(19) United States
(12) Patent Application Publication
(10) Pub. No.: US 2003/0079693 A1
(43) Pub. Date: May 1, 2003

(54) Toy for animals

(76) Inventor: Claudius Jager, Boulder, CO (US)

Correspondence Address: ROBERT W. BECKER & ASSOCIATES, 707 Highway 66 East, Suite B, Tijeras, NM, 87059, US

(21) Appl. No.: 10/213,870

(22) Filed: Aug. 6, 2002

(30) Foreign Application Priority Data
Oct. 25, 2001 (DE) 101 52 070.0

(51) Int. Cl. A01K 29/00

(52) U.S. Cl. 119/707

(57) ABSTRACT

A toy for animals, especially for dogs, is provided. The toy has a body having optional recesses on an outer surface thereof. The body comprises a core of a first, hard polymeric material, and a covering of a second, soft polymeric material, especially of rubber or a rubber-like material.

### BACKGROUND OF THE INVENTION

The present invention relates to a toy for animals, especially for dogs, and has an elongated body of polymeric material that the animal can grasp with its mouth and can chew, and that on its surface may be provided with recesses in the form of grooves or bores into which the teeth of the animal can penetrate, or may be smooth.

Toys of this type are known, for example, from U.S. Pat. No. 4,802,444 and U.S. Reissue Pat. 34,352. Such toys serve not only for keeping the animal busy and entertained, but also for caring for the teeth. The teeth of the animal penetrate or enter into the recesses, whereby food residue and coatings on the teeth are wiped off against the edges of the recesses. It is therefore desirable for hygienic reasons that the animal occupy itself frequently with the toy.

It is therefore an object of the present invention to improve the toy of the aforementioned general type such that it is particularly interesting to an animal and stimulates the animal to occupy itself with the toy.

### BRIEF DESCRIPTION OF THE DRAWINGS

This object, and other objects and advantages of the present invention, will appear more clearly from the following specification in conjunction with the accompanying schematic drawings, in which:

FIG. 1 is a partially longitudinally cross-sectioned view of one exemplary embodiment of the inventive toy for animals;

FIG. 2 is a cross-sectional view through the toy of FIG. 1,

FIG. 3 shows a modified embodiment of the inventive toy, as well as a schematic illustration of the muzzle of a dog;

FIG. 4 and 5 show further modified embodiments of the inventive toy;

FIG. 5a and 5b are enlarged cross-sectional views of the embodiments of FIG. 4 and 5 respectively;

FIG. 6 is a partially cross-sectioned view of another exemplary embodiment of the inventive toy;

FIG. 6a is a view of one end of the toy of FIG. 6;

FIG. 6b is a view of the opposite end of the toy of FIG. 6;

FIG. 7 is a view similar to that of FIG. 6, but of a pear-shaped embodiment; and

FIG. 8 is a view similar to that of FIG. 6, but of an oval-shaped embodiment.

### SUMMARY OF THE INVENTION

The animal toy of the present invention is characterized primarily in that it comprises a core of a hard polymeric material with a covering of a soft polymeric material, especially a rubber-like polymeric material.

As a consequence of the inventive configuration of the toy, an animal has the impression of a bone that is covered with meat, whereby the core can be hollow in order to imitate a hollow marrow-filled bone, and possibly to hold treats, acoustical or optical effects, etc. A scented and/or flavored insert to stimulate an animal to play with the toy would also be possible. Pursuant to one embodiment, the toy has the shape of a bone, having a narrow central portion and wider end portions, but can also have the shape of a ball or an oval shape. The toy is preferably rotationally or axially symmetrical, and may be provided with optional grooves that extend in the circumferential or peripheral direction. The toy thus on the one hand has a shape that is comfortable for the animal and on the other hand is easy to manufacture.

The material of the covering is preferably natural rubber (NR) or a mixture of natural rubber and styrene-butadiene rubber (SBR), whereby the material of the covering can be chemically bonded with the core without it being necessary to dispose an additional layer of a binder, an adhesive or the like between the core and the covering, although it would be possible to do so. Alternatively, or in addition thereto, a mechanical interconnection between the hard plastic core and the outer rubber coating, for example via undercuts and/or over-molding, would also be possible. The harder material of the core is preferably a thermoplastic that is particularly suitable for forming this chemical bond. Such a material can be a polyamide (PA) or a modified polyphenylene ether (PPE). With such a combination of materials, it is possible to simulate a marrow-filled bone that is covered with meat. The toy is durable and stable against external forces that tend to attack and destroy it, and it is easy to manufacture.

The hard core, which is fixedly connected with the covering, improves the durability and stability of the toy. The elastic covering ensures that the toy jumps or rebounds when it falls upon a hard surface, and thus enables an entertaining and exciting toy for the animal. Pursuant to one advantageous embodiment of the invention, with an axially symmetrical, bone or dumbbell shaped toy, the peripheral beads or ridges have a slightly differing diameter, so that the toy rolls along a curved path in a manner not foreseeable by the animal, thus making play with the toy even more interesting.

The hollow embodiment of the core furthermore makes it possible to dispose therein an electronic device that produces musical tones, acoustical effects, or light effects, and/or releases scents or flavors, thus exerting a particular fascination for the animal. The electronic device can be embodied in such a way that it produces different effects depending upon how the animal manipulates the toy.

Further specific features of the present invention will be described in detail subsequently.

### DESCRIPTION OF PREFERRED EMBODIMENTS

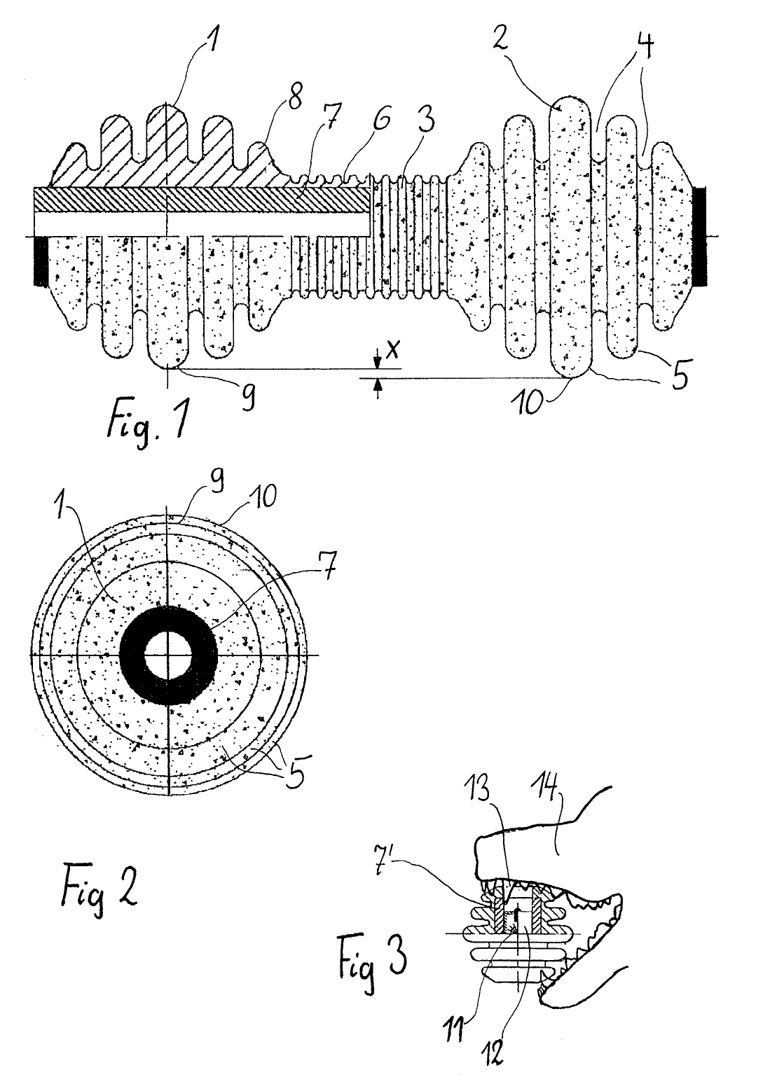

Referring now to the drawings in detail, the toy of FIGS. 1 and 2 is axially symmetrical and, like a bone, has a dumbbell-shaped configuration with spherical enlargements at the end portions 1 and 2, which are interconnected by a narrow central portion 3. The enlarged end portions 1,2 can be provided with a plurality of optional deep grooves 4 that extend in the circumferential direction and divide each of the end portions into groups of five or six ridges 5. When the animal, for example a dog, plays with the inventive toy, the teeth of the animal penetrate or enter into the grooves 4 when the animal grasps the toy with its mouth. In so doing, the animal's teeth and possibly also its gums rub against the walls of the grooves 4 or against the ridges 5, and in so doing are cleaned of food residue, coatings on the teeth, etc. The central portion 3 is provided with a plurality of smaller circumferential grooves that can serve to increase the ability to grasp the toy and to clean the smaller teeth of the animal.

The important thing is that the toy has a core 7 and sheathing or covering 8, each of which is made of a different material. The covering 8 comprises a soft, elastic polymeric material, in particular rubber or a rubber-like material. The covering 8 is preferably comprised of natural rubber or a mixture of natural rubber and styrene-butadiene rubber, and has a hardness of 40-60, preferably 45 or 55 Shore A. The core 7 comprises a material that is harder than the material of the covering 8, preferably being a polyamide (PA) or modified polyphenylene ether (PPE). The core 7 has a hollow interior, and comprises a cylindrical tube with relatively thick walls; the end faces of the core are open. Thus, the toy has the appearance of a hollow, marrow bone that is covered with soft meat.

The end portion 1 has its greatest diameter or radius where indicated by the reference numeral 9, and the end portion 2 has its greatest diameter or radius at 10. The two radii differ from one another by the amount x. Due to these differing measurements, the toy will roll on a curved path, and will jump around, in a non-foreseeable manner. This makes playing with the toy more interesting for an animal.

For a dog of the K9 size, the maximum diameter of 9 or 10 can be approximately 70 mm.

In conjunction with FIGS. 3-5, an embodiment of the inventive toy will be described that is provided with an additional unit in the form of an electronic device that sends out acoustical or optical signals, and thus provides an additional attraction or fascination for the animal to encourage it to play with the toy. The electronic device can, for example, be provided with a light emitting diode that is supplied from a small battery and constantly blinks. However, the electronic device can also be provided with sensors that establish if the animal is manipulating the toy and possibly with what effort, and in conformity therewith can emit signals, such as musical notes and noises. Such sensors can, for example, react to pressure, shaking, or during throwing and/or striking of the toy on the ground.

The electronic device 11 is disposed within a pressure-tight capsule or shell 12 that is sealed against moisture and that is inserted into a tubular core 7′. The toy illustrated in FIGS. 3 to 5 is not a complete, dumbbell-shaped imitation of a bone, as is the toy of FIG. 1, but rather is a round object that has grooves and that corresponds to one of the end portions of the object of FIG. 1. However, an electronic device of the type described in the following can also be installed into a toy of the type shown in FIG. 1. An advantage of the shorter construction of FIGS. 3 to 5 is that a blinking light on the electronic device is very visible.

The capsule 12 with the electronic device 11 is disposed to such a depth into the tubular core that it cannot be reached and damaged by the teeth 13 of an animal 14 playing with the toy (see FIG. 3).

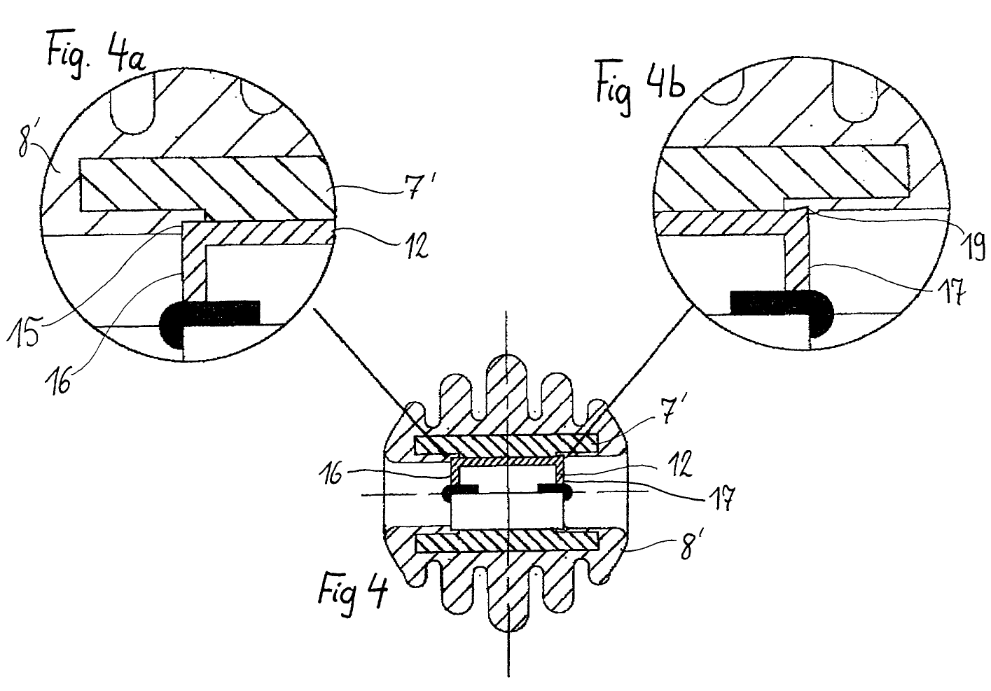

The securement of the capsule 12 in the tube can be effected in various ways. With the embodiment of FIG. 4, the soft, rubber material of the covering 8′ is guided about the end faces of the tubular core 7′ to the inner side thereof. The ends of the capsule 12 rest against the soft material and are held by the elastic forces thereof. In this connection, the two ends and their abutment surfaces have different configurations. On one side, the rubber mixture is provided on the inner side of the tubular core 7′ with a step 15 that serves as an abutment for the one end 16 of the capsule 12 (see the enlarged cross-sectional view of FIG. 4a). On the other side, there is no such step. At its end 16, the capsule 12 has a cylindrical configuration, while on the other side 17 its diameter widens slightly to form a protrusion 19. During assembly, the capsule 12 is inserted into the tubular core 7′ until it abuts against the step 15. It is then held in a wedged manner by means of the protrusion 19. Thus, after completion of fabrication of the toy from the core and covering, the capsule 12 can be installed, so that the processes that are effected at high temperatures, such as vulcanization and curing of the polymeric material, do not have to be interrupted.

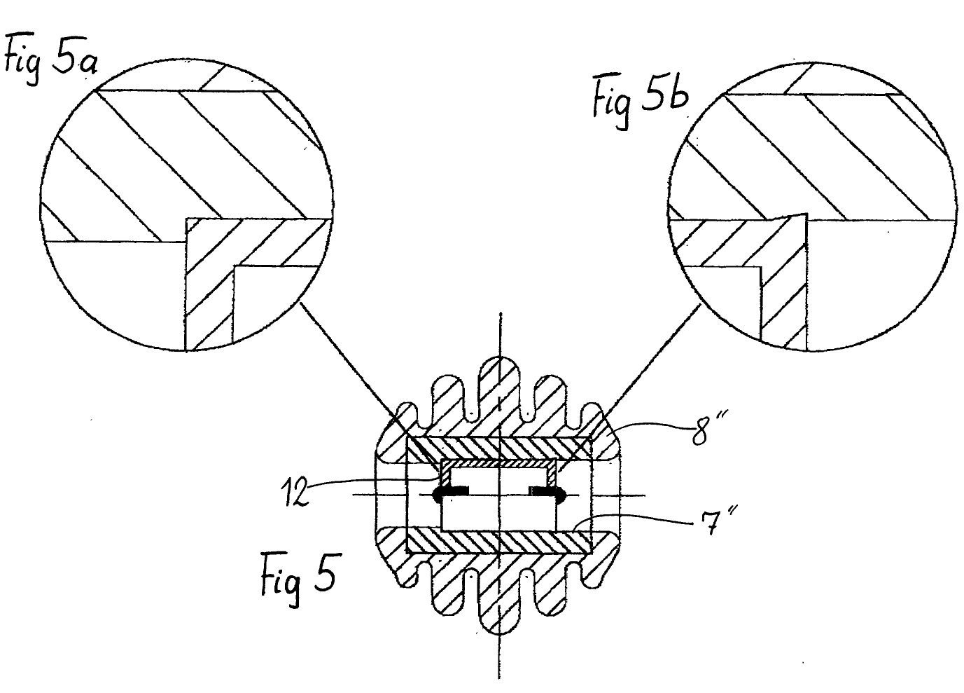

In the embodiment of FIG. 5, the soft material of the covering 8″ ends at the end faces of the tubular core 7″. The capsule 12 is inserted directly into the thermoplastic tube 7″, being held, for example, by a press fit. In other respects, securement is analogous to that of the embodiment of FIG. 4.

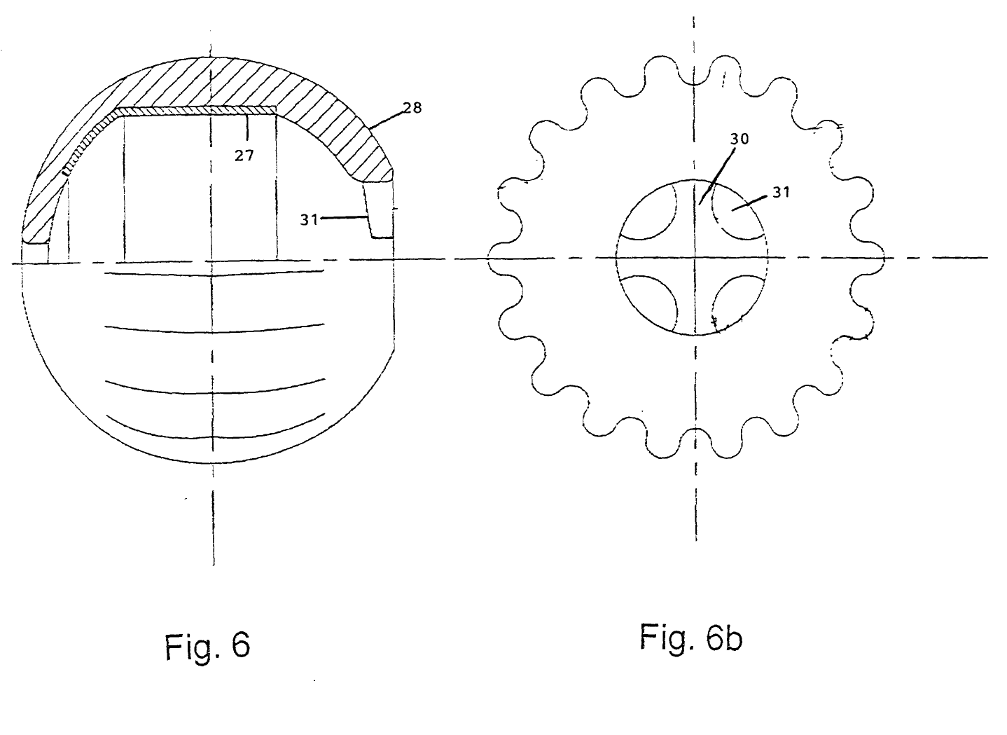

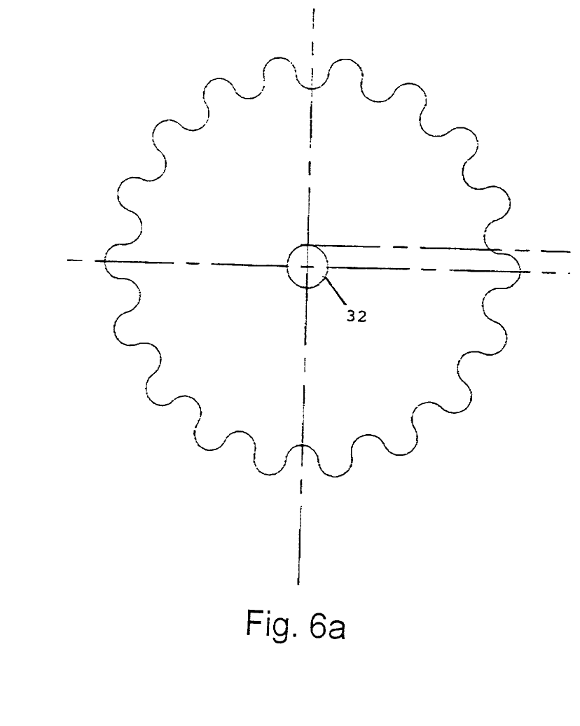

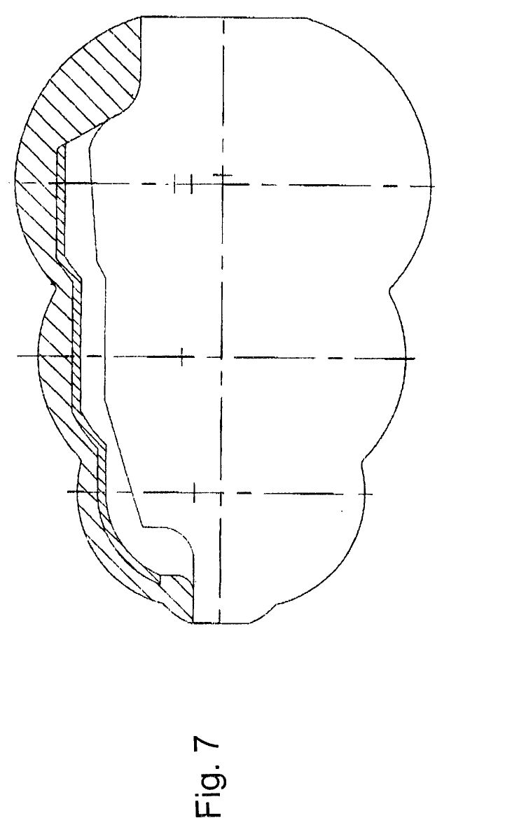

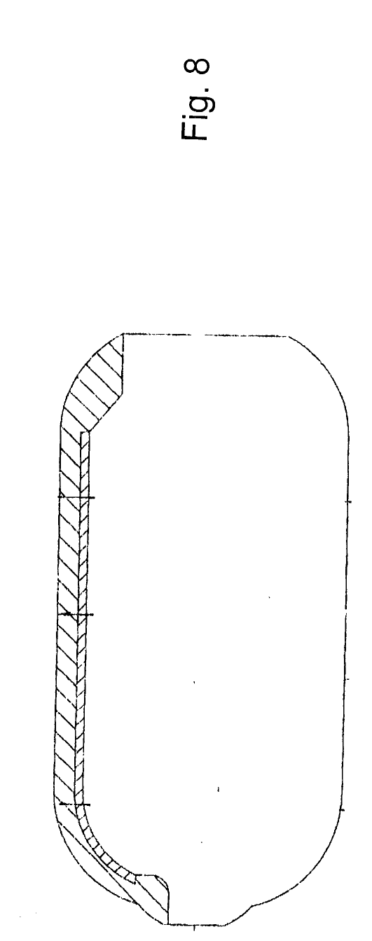

FIGS. 6-8 show modified embodiments of the inventive toy, with all of these embodiments having a hollow interior. Several different shapes are shown, and it will be understood that variations thereof are also possible.

With the embodiments illustrated in FIGS. 6-8, the harder core or insert 27, which is again provided to reinforce and to provide to an animal the idea of a hard bone covered with flesh as simulated by the softer covering 28, is relatively thin. For example, pursuant to one exemplary embodiment of the inventive toy, the hard core 27 has a thickness of only 2 mm. A similar core could also be provided for the embodiments of FIGS. 1 and 2 or 3-5. The same materials as previously described are contemplated for all of the embodiments.

The embodiments illustrated in FIGS. 6-8 can also be provided with optional grooves on at least part of the surface of the covering 28. These optional grooves can be in the form of shallow grooves or ribs.

The embodiments of FIGS. 6-8 can also, as shown in particular in FIGS. 6b, have a dispensing/holding hole 30 at one location only. Treats can be inserted into the hollow interior of the toy through this hole 30. Flaps or retaining elements 31 can also be provided on the covering 28, and can project into the area of the hole 30, to hold treats and to prevent them from being released too easily. To provide an emergency breathing passage in the event that the toy gets stuck in the throat of an animal, and blocks its natural breathing process, another portion of the covering 28, such as the opposite end of the toy, can optionally be provided with a small hole (see in particular FIG. 6a), which is not intended to hold treats.

The specification incorporates by reference the disclosure of German priority document 101 52 070.0 filed Oct. 25, 2001.

The present invention is, of course, in no way restricted to the specific disclosure of the specification and drawings, but also encompasses any modifications within the scope of the appended claims.

I claim:

1. A toy for animals, comprising:
comprising a core of a first polymeric material, and a covering of a second polymeric material that is softer than said first polymeric material, wherein said covering is disposed outwardly over said core.

2. A toy according to claim 1, wherein said second polymeric material is rubber or some other elastic material.

3. A toy according to claim 1, wherein said first polymeric material of said core comprises polyphenylene ether or a polyamide, and the second polymeric material of said covering comprises natural rubber or a mixture of natural rubber and styrene-butadiene rubber.

4. A toy according to claim 3, wherein said second polymeric material of said covering has a hardness of 40-60 Shore A.

5. A toy according to claim 3, wherein said second polymeric material of said covering is chemically bonded to said first polymeric material of said core without additional binders or adhesives, or wherein said covering and core are mechanically interconnected.

6. A toy according to claim 1, wherein said toy has the shape of a bone, including end portions that are interconnected by a central portion, and wherein said end portions are larger than said central portion.

7. A toy according to claim 1, wherein said toy is axially symmetrical or mirror symmetrical.

8. A toy according to claim 6, wherein one of said end portions has a maximum diameter that is slightly greater than a maximum diameter of the other of said end portions.

9. A toy according to claim 1, wherein said core is hollow.

10. A toy according to claim 1, wherein said core is tubular.

11. A toy according to claim 10, wherein said tubular core is open at at least one end face thereof.

12. A toy according to claim 1, wherein said toy is spherical.

13. A toy according to claim 9, wherein an electronic device is disposed within said hollow core, and wherein said electronic device can produce acoustical effects or light effects.

14. A toy according to claim 13, wherein said electronic device is surrounded by a sealing capsule that is disposed in such a way in said core, which is tubular and is open at end faces thereof, that a spacing of said end faces of said core from said capsule is considerably greater than an average length of the largest teeth of an animal for which said toy is provided.

15. A toy according to claim 13, wherein said electronic device is surrounded by a sealing capsule that is disposed in such a way in said core, which is tubular and open at at least one end face thereof, that an end face of said capsule rests against an abutment in said core, and wherein at an oppositely disposed end face an adjoining outer surface of said capsule is provided with a protrusion.

16. A toy according to claim 15, wherein said capsule is cylindrical.

17. A toy according to claim 15, wherein said covering is guided about end faces of said tubular core to an inner surface thereof, and wherein ends of said capsule rest against the material of said covering.

18. A toy according to claim 1, wherein ribs are provided on at least a portion of an outer surface of said covering.

19. A toy according to claim 1, wherein said covering is provided with a hole that communicates with a hollow interior of said toy.

20. A toy according to claim 19, wherein said covering is provided with at least one retaining element that projects into said hole to retain a treat therein.

21. A toy according to claim 19, wherein said covering is provided with a further hole that communicates with said hollow interior of said toy and serves as an emergency breathing hole.
